(19) United States
(12) Patent Application Publication
(10) Pub. No.: US 2006/0284727 A1
(43) Pub. Date: Dec. 21, 2006

(54) Method and system with functionality for finding range between an electronic tag reader and tag

(75) Inventor: Kurt Ellis Steinke, Springfield, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/155,141

(22) Filed: Jun. 16, 2005

(51) Int. Cl. H04Q 5/22

(52) U.S. Cl. 340/10.31; 342/127

(57) ABSTRACT

In an embodiment there is an electronic tag having an encoded bit data pattern in a portion of a data field from the tag resulting in a modulated backscatter signal from the tag when the tag responds to a read command from an interrogator. In an embodiment there is a method for determining the range between an antenna of an interrogator and an electronic tag comprising the steps of: 1) singulating an electronic tag of interest; 2) sending a range command to the electronic tag of interest; 3) detecting a modulated backscatter response from the electronic tag of interest; 4) measuring a time delay between a transmitted modulated carrier signal from the interrogator and the modulated backscatter response; 5) calculating a distance between the antenna and the electronic tag using the time delay; and 6) reporting the distance.

### BACKGROUND

The field of the disclosure relates to electronic tags such as RFID tags and, in more particular, to methods and system functionality for determining range between an interrogator and the electronic tag.

The use of Radio Frequency Identification (RFID) transponders or tags to identify an object or objects is well known. Typically, when these tags are excited they produce or reflect a magnetic or electric field at some frequency, which is modulated with an identifying code or other useful information. The tag may either be active or passive. Active tags have a self-contained power supply. Passive tags require external excitation when they are to be read within the detection volume of a reader. In passive tag systems, the interrogator or reader contains a transmitting antenna for sending an exciting frequency signal to the passive tag. The transmitting antenna is positioned at the portal end and adjacent to an antenna for receiving a modulated signal (magnetic or electromagnetic) produced by the excited tag. This modulated signal identifies the tag and consequently, the object attached thereto. Alternately, a single antenna may be used to transmit and receive signals.

RFID systems are radio communication systems that communicate between a radio transceiver, called an interrogator and the transponders or tags. In RFID systems, the interrogator communicates to the tags using modulated radio signals and the tags respond with modulated radio signals. After transmitting a message to the tag (called the downlink), the interrogator then transmits a continuous-wave radio signal to the tag. The tag modulates the continuous-wave signal using modulated backscattering where the antenna is electrically switched, by the modulating signal, from being an absorber of RF radiation to being a reflector of RF radiation. This modulated backscatter allows communication from the tag to the interrogator (called the uplink). Conventional modulated backscattering systems identify an object passing into range of the interrogator and store data onto the tag and then retrieve that data from the tag at a later time.

U.S. Pat. No. 6,707,376 B1, issued to Patterson et al., entitled “Pulsed Power Method For Increased Read Range For A Radio Frequency Identification Reader,” teaches a method of locating a passive tag in an increased reading range. The RFID reader transmits a pulsed interrogation signal and receives a response signal from the tag. However, the reader only returns the presence of the tag and does not return the range the tag is from the reader.

U.S. Pat. No. 6,577,238 B1, issued to Whitesmith et al., entitled “RFID Detection System,” teaches a way to position monitor active RFID tags. The reader control system compares the signals received from an active tag at different times to detect a change in the range. The reader does not distinguish the reflected signal of a passive tag from that of any object in the environment.

U.S. Pat. No. 6,046,683, issued to Pidwerbetsky et al., entitled “Modulated Backscatter Location System,” teaches an RFID interrogator sending a modulated signal to one or more RFID tags. The interrogator is at a known location and is in motion at a known velocity with respect to a tag. The tag demodulates the signal, generates a subcarrier signal and backscatter modulates the reflection of the signal using the subcarrier signal. The interrogator determines the tag's relative direction from the location and velocity of the interrogator and a Doppler shift of the subcarrier signal. However, the reader only returns the presence of the RFID tag and does not return the range of the RFID tag.

Thus the present inventor has recognized a need for a method and system that accurately determines a range between an interrogator and an electronic tag when interrogated by the interrogator.

### SUMMARY

The present embodiment is directed to a method and system that determines the range between an electronic tag and an interrogator. For example, in one embodiment the range between the interrogator and the tag may be determined by measuring the time delay or phase shift of a modulated backscattered signal and a modulated carrier signal and then calculate the distance between an interrogator antenna and electronic tag by using the phase shift or time delay.

In an embodiment there is a passive RFID tag encoded with a bit pattern for determining a range between a RFID interrogator and a RFID tag resulting in a modulated backscatter for an interval of time when responding to a read command from the interrogator.

In an embodiment there is a method for determining the range between an antenna of an interrogator and an electronic tag comprising the steps of: 1) singulating an electronic tag of interest; 2) sending a range command to the electronic tag of interest; 3) detecting a modulated backscatter response from the electronic tag of interest; 4) measuring a time delay between a transmitted modulated carrier signal from the interrogator and the modulated backscatter response; 5) calculating a distance between the antenna and the electronic tag using the time delay; and 6) reporting the distance.

These and other aspects of the disclosure will become apparent from the following description, the description being used to illustrate preferred embodiments when read in conjunction with the accompanying drawings.

### BRIEF DESCRIPTION OF THE DRAWINGS

FIG. 1 illustrates a functional block diagram of an RFID interrogator with barcode reading capability in a preferred embodiment.

FIG. 2 illustrates a functional block diagram for tag reading by singulation in a preferred embodiment.

FIG. 3 is a diagrammatic view of a combined RFID system comprised of an RFID reader, optical code reader and data terminal according to a preferred embodiment.

FIG. 4 illustrates a flow diagram for singulation and range with embedded ranging bits in a RFID tag in a preferred embodiment.

FIG. 5 illustrates a flow diagram for ranging a RFID tag with a built-in range command.

FIG. 6 illustrates a flow diagram for ranging after singulation with embedded ranging bits in a RFID tag.

FIG. 7 illustrates a modulated backscattered signal from a RFID tag during a portion of a read period.

FIG. 8 illustrates a modulated backscattered signal with a phase shift or time delay during a portion of a read period.

### DETAILED DESCRIPTION OF THE PREFERRED EMBODIMENTS

While the preferred embodiments are described below with reference to a RFID tag, a practitioner in the art will recognize the principals described herein are viable to other types of electronic tags as well as in other applications.

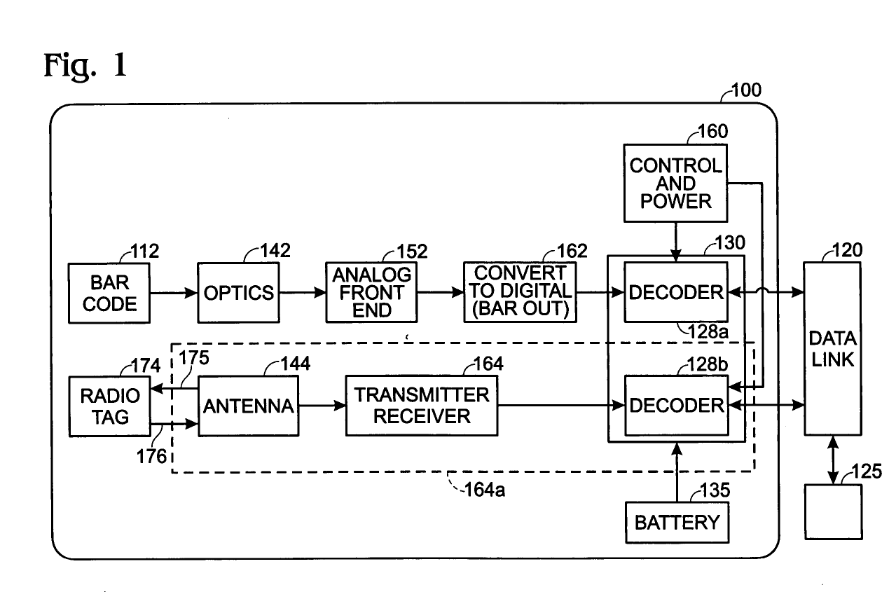

FIG. 1 illustrates a multiple-technology data reader 100, according to an embodiment, including an optics module 142 and analog front end 152 components for reading a bar code 172. The signal generated by the analog front end 152 is converted to a digital signal by an analog to digital (A/D) converter 162 which is connected to a device microcontroller 130. The reader 100 further includes an antenna 144 wherein a carrier radio frequency (RF) signal 175 is transmitted to the RFID tag 174 and the RFID tag 174 emits a backscatter signal 176 received back through the antenna 144. In this application, the barcode reading components and interrogator 164a are powered by a battery 135.

A portion of a data field of the RFID tag 174 may be encoded with a fixed frequency bit pattern resulting in a particular backscatter response when the tag 174 is interrogated. The particular backscatter response may occur when the portion of the data field of the RFID tag 174 that is encoded with a bit pattern is interrogated in response to a first read command from the reader 100. In addition, the data field of the RFID tag 174 may be encoded with a fixed frequency bit pattern resulting in a particular modulated backscatter response when interrogated. The particular modulated backscatter signal may occur when the portion of the data field of the RFID tag 174 that is encoded with the bit pattern is interrogated in response to a second read command from the reader 100. Furthermore, a portion of the data field of the RFID tag 174 may be encoded with a fixed frequency bit pattern resulting in a particular modulated backscatter signal response for a fixed or indefinite interval of time. The particular modulated backscattering may occur when the portion of the data field of the RFID tag 174 that is encoded with the bit pattern is interrogated for a specific time interval in response to a third read command from the reader 100. In another embodiment, the fixed frequency bit pattern is substitutable for a specific data pattern.

The time interval of the read command may be selected from variety values of time. For example, the interval of time may be until the carrier signal from the multiple technology reader 100 is turned off. Alternately, a time interval of 10 seconds may be used. A desired time interval will assist in measuring the time delay or phase shift of the RFID tag modulated backscatter response 176 during a period of maximum backscatter from the tag to find the range of the tag 174.

Depending on the read command, the multiple-technology data reader 100 may interrogate the tag 174 and provide a variety of tag 174 predicted responses including a backscattered response, a modulated backscattered response and a modulated backscattered response for a time interval. The predicted response may be used with a transmitted carrier signal or modulated carrier signal, to determine the distance between the electronic tag and an antenna of the interrogator, when measuring the time delay or phase shift of the predicted response and the carrier signal or modulated carrier signal.

The transmitter/receiver 164 component of an RFID interrogator 164a sends and receives, respectively, the RF carrier signal 175 and backscatter signal 176. The transmitter/receiver 164 of interrogator 164a is connected to the device microcontroller 130. The microcontroller 130 includes a decoder and control interface 128a for the bar code reader and another decoder and control interface 128b for the RFID interrogator. The decoder and control interfaces 128a and 128b are connected to a device communications control and power unit 160. The multiple technology data reader 100 further includes a trigger unit 130a which initiates the control and power signals, both to and from the device communications control and power unit 160 on the microcontroller 130. The microcontroller 130 is connected to a host computer 125 via a USB link 120, or other suitable interfaces. One such multiple-technology reader is described in U.S. Pat. No. 6,415,978, issued to McAllister, entitled “Multiple Technology Data Reader For Bar Code Labels And RFID Tags,” the entire contents of which are incorporated herein by reference. The McAllister patent may use the method of determining a range between an interrogator and a tag.

The reader device interface 128a has input/output endpoints enabling the host computer 125 to use a default control method to initialize and configure the reader device interface 128a. The input/output endpoints allow the host computer 125 to send data to the reader interface 128a. Furthermore, the reader device interface 128a will send data to the host computer 125. The data may be sent in both directions between the reader device interface 128a and the barcode reader subsystem via a communications link or parallel bus.

Likewise, a reader device interface 128b has input/output endpoints enabling the host computer 125 to use a default control method to initialize and configure the reader device interface 128b. The input/output endpoints send data to the reader device interface 128b. In the reverse, the reader device interface 128b may send data to the host computer 125. Data may be sent in both directions between the reader device interface 128b and the barcode reader subsystem via a communications link or parallel bus.

When the trigger 130a energizes the RFID interrogator 164a, singulation may provide an initial reading of only those tags that are in the close proximity to the antenna 144. As the RF transmitting power increases, the read volume grows steadily up to a maximum that a particular interrogator permits. Singulation provides better restriction of the read zone than does a tight or narrow narrow antenna beam. For example, singulation may use a binary search tree having a population of RFID tags for locating a tag of interest, for example tag 174. The tag 174 may contain a fixed frequency bit pattern in a portion of the data field of the tag 174, whereby the multiple-technology reader 100 will receive a modulated backscatter signal 176 after responding to a command from the interrogator 164a.

The range of the interrogator 164a antenna from the tag 174 may be determined when a portion of the tag's data field is encoded with a fixed frequency bit pattern that results in a predicted response when the tag 174 is interrogated. The fixed frequency may be a plurality of frequencies or data patterns that are encoded onto the tag. A particular predicted response from the tag 174 may occur when the portion of its data field is interrogated in response to a read command. Depending on the read command, the multiple-technology data reader 100 may interrogate the tag 174 and provide a variety of tag 174 predicted responses including a backscattered response, a modulated backscattered response and a modulated backscattered response for a time interval. If the predicted response is a modulated backscatter during a time interval, the time interval may be selected from a variety of values that allow adequate processing time. The predicted response may be used with a transmitted carrier signal or modulated carrier signal, to determine the distance between the electronic tag and an antenna of the interrogator, when measuring the time delay or phase shift of the predicted response and the carrier signal or modulated carrier signal.

The read command may be activated automatically through a software algorithm in response to activating the trigger 130a. Typically, the read commands are separate alternatives and depend on the encoding for a particular tag. However, the different read commands may be encoded onto one tag in different portions of the tag. Consequently, the read command may be activated from the trigger 130a by a single trigger click, a double trigger click or a triple trigger click to engage the first, second and/or third read command. Finally, it might be desirable to have a software switch, such as a dialog box on the display for the alternate read commands.

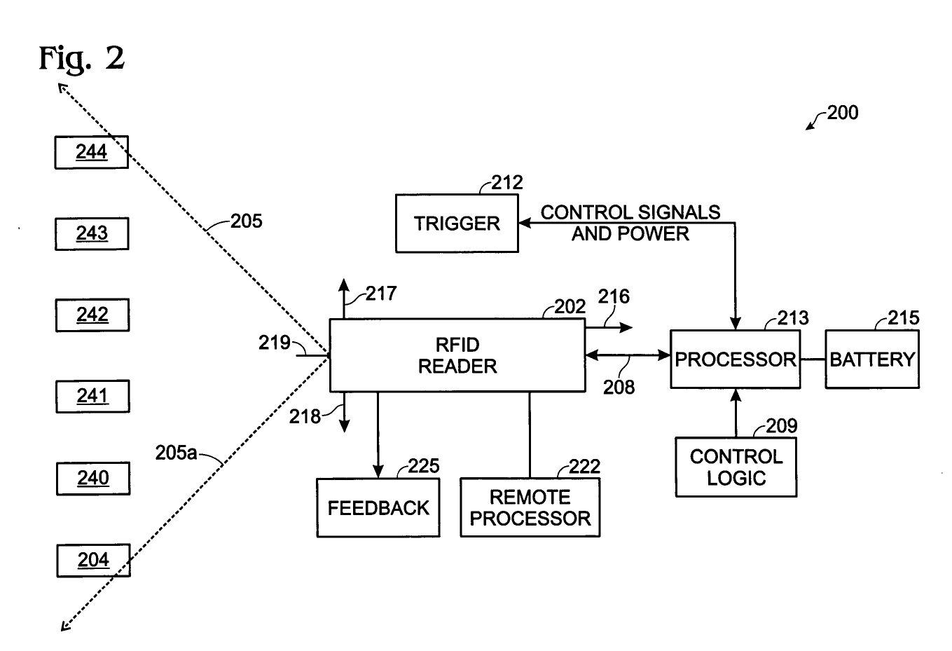

In FIG. 2, RFID system 200 illustrates a block diagram according to a preferred embodiment. The system 200 uses a RFID reader 202 to interrogate for a particular RFID tag or tags in a plurality of RFID tags, including but not limited to, tags 204, 240, 241, 242, 243 and 244. The RFID system 200 is preferably a fixed in front of the reader. Alternately, the RFID reader 202 is substitutable for a hand-held reader, wherein RFID reader 202 passes over the RFID tags 204, 240, 241, 242, 243 and 244. A portion of the data field of the tags 204, 240, 241, 242, 243 and 244 may be encoded with a fixed frequency bit pattern to produce a particular backscattering. For example, the tags 204, 240, 241, 242, 243 and 244 may each have a different fixed frequency from about 860 MHz to about 960 MHz. This frequency range may allow the reader 202 to select through protocols and antennas or a combination thereof to determine which frequency is desired for a particular tag.

One such reader that may interrogate a tag having a data field encoded with a bit pattern is disclosed in U.S. Pat. No. 5,864,129, issued to Boyd, entitled “Bar Code Digitizer Including Voltage Comparator,” the entire contents of said patent are incorporated herein by reference. The reader 202 may include software having an algorithm for sending a query to a RFID tag to obtain a known or predicted response. The reader 202 may transmit a carrier signal during the known response period or at least a portion of the response period. The reader 202 detects the known response which may be a backscatter, a modulated backscatter or a modulated backscatter for a time interval, and measures the time delay or phase shift between the known or predicted response and the carrier signal. The reader 202 then calculates the range between the interrogator and the tag. Alternately, the carrier signal may be substituted for a modulated carrier signal that will increase the accuracy of measuring the time delay or phase shift. Using the modulated carrier signal instead of a carrier signal reduces irregular variations in the backscattering from the tag of interest.

The backscattering from a tag of interest occurs when that portion of the RFID tag's data field is returned in response to a read command from the reader 202. The tags 204, 240, 241, 242, 243 and 244 may be encoded with additional data or a fixed frequency bit pattern to further return data that result in modulation of its backscatter signal for a portion of the response of the tag. In addition, the read command may initiate the interrogator for a fixed or an indefinite interval to send a carrier signal and then receive a modulated signal at a particular frequency from the tag of interest. For example, the interval may be set for 10 seconds, until the subcarrier from the interrogator is turned off or alternately for any value of time as required to obtain the known or predicted response from a tag of interest.

The RFID reader 202 may be connected via a USB link 208 or other suitable interface to processor 213. The interface link may be hardwired to an infrared modem connection, a RF modem connection, a combination of connections or any suitable connection. In addition, there may be software with a particular algorithm and control circuit as part of the microprocessor 213 for configuring the automatic inventory command of a multi-protocol and/or multi-antenna reader to be configured to exclude certain protocols and/or antennas. However, many applications do not read the full range of tag types or orientations. Consequently, automatically excluding certain protocols and/or antennas by using the automated search algorithm may save battery 215 power and provide a more efficient operation.

The RFID reader 200 may also include a self-contained micro-processor and be capable of storing data, and may or may not interface with a remote processor 222. The processor 213 receives control input from logic control 209 for communication with the reader 202. The logic control 209 may be programmable and part of processor 213 or may be separate. An activation switch, such as trigger 212, provides control signals and power to processor 213. Consequently, the switch may implement a singulation scheme to locate a RFID tag of interest, for example, tag 241 from amongst the RFID tags 204, 240, 241, 242, 243 and 244. In addition, the software and the control circuit located within the microprocessor 213 may maintain a count of the number of RFID tags found per each singulation attempt. The count may be at each protocol and/or antenna and automatically exclude certain protocols and/or antennas and/or combinations thereof from an inventory algorithm based on that history which results in a more effective singulation operation. Furthermore, once a tag of interest is singulated by a binary search, or other search method, the tag may backscatter in response to the reader 202 when the portion of the tag's data field is returned in response to a read command from the reader 202. The tag may be encoded with a data pattern for an alternate read command to return the data from the tag as a modulated backscatter signal for a portion of its response. In addition, the tag may be encoded with a data pattern for another alternate read command so that the modulated backscatter signal responds at a particular tag frequency for a fixed or indefinite interval. The interval may be until the next higher frequency is attempted by the reader 202.

The power-density-time (PDT) control that provides a ramped power control is accomplished by use of a singulation trigger 212. The singulation begins when the trigger 212 is pulled and held. The read continues for as long as the trigger 212 is held, up to the point of maximum power. Depending on what RFID tag is to be identified from the tags 204, 240, 242, 242, 243 and 244, the trigger 212 would be pulled to generate a transmitter power. The transmitting power provides the desired sensing volume between 205 and 205a using antenna 219, wherein a particular tag is identified from among the tags 204, 240, 241, 242, 243 and 244. The software and control circuit located within the microprocessor 213 may also contain an inventory algorithm that excludes a variety of protocols, antennas and/or combinations thereof, which may significantly increase the performance of the reader 202.

The RFID reader 202 may optionally include a feedback mechanism 225. One such mechanism may comprise a progress bar on a LCD increasing as the range between the interrogator and tag decreases or vice versa. This feedback allows the user to judge whether or not the user is getting close or closer to the tag. Alternately, the feedback mechanism 225 may comprise an auditory feedback that generates an audible signal when a RFID tag is read and changes in pitch or pulse frequency as the range to the tag varies. The auditory feedback may include, but is not limited to, increasing a pitch sequence of tone-beeps working with the increasing range.

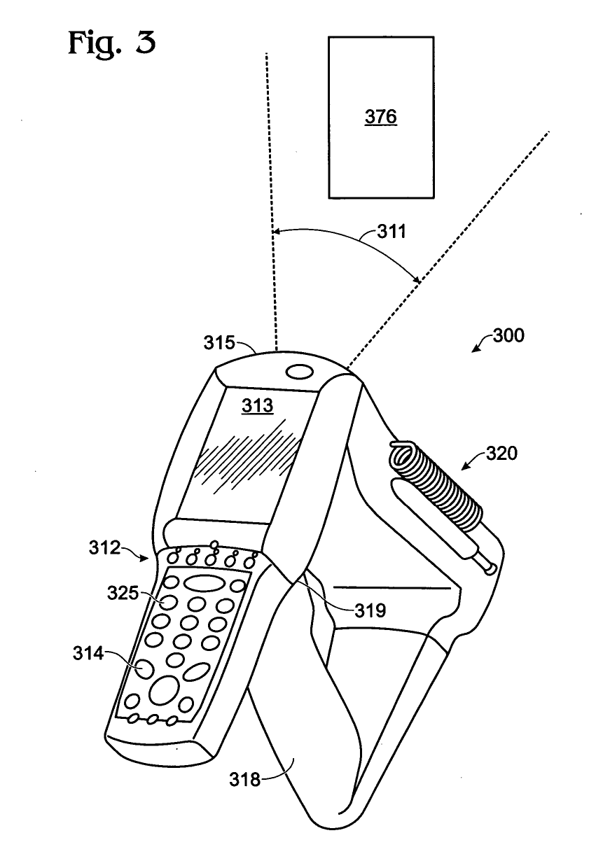

FIG. 3 illustrates a handheld combination reader 300 comprising a portable terminal section 312, a handle section 318 and an RFID interrogator section 320. The portable terminal section 312 includes a touch screen display 313 and a keypad section 314 for providing control or data input into the terminal or visual display. Also, the terminal 312 includes a front window 315 through which a data reading device such as an imager is operative to read optical codes. The reader 300 is preferably a combination system with the various functions controlled by the terminal 312. Input is entered into the reader 300 by using the touch display screen 313 or keypad 314. Within a particular mode of operation the user may activate a particular read operation by actuating the trigger 319 or a scan key button 325. The trigger 319 is located on the front of the handle 318. The scan key button 325 is located on the keyboard 314. In addition, another virtual switch may be used on the touch screen display 313 to activate a read operation.

In order to find the range of an electronic tag 376, the tag 376 may be encoded with a fixed frequency bit pattern providing a known or predicted response when the tag is interrogated by the combination reader 300. A read command from the reader 300 is issued so that the tag 376 alone responds with its known or predicted response. The tag 376 backscattered response may be measured during the backscatter maximum in the known or predicted tag response of the tag 376. The reader 300 may use software having an algorithm for finding the range between the interrogator antenna and an electronic tag including the steps of: (1) singulating a tag of interest detecting a backscatter response; (2) sending a range command; (3) detecting the predicted response; (4) measuring the phase shift or time delay; (5) calculating the range; and (6) reporting the distance.

To determine the range of an electronic tag 376, the tag is implemented with a fixed frequency bit pattern or a data pattern, in a portion of a data field in the tag 376, in order that a predicted response may be reflected from the data field when the tag 376 is interrogated by reader 300. A first implementation is to encode the tag 376 wherein a predicted response may be a backscatter response when the data portion is returned in response to a read command from the reader 300. A second implementation is to encode the tag 376 wherein a predicted response may be a modulated backscatter response when the data portion is returned to a read command from the reader 300. A third implementation is to encode the tag 376 wherein a predicted response may be a modulated backscatter response during a fixed or indefinite interval. The interval may be until the carrier signal from the interrogator is turned off for various periods or lengths/intervals of time.

The electronic tag 376 may have ranging data encoded into the electronic product code field. The communication between the RFID reader and tag occurs in a packetized manner where a single packet contains a complete command from a reader and a complete response from a tag. For example, a complete command from a reader may consist of eight fields and five parity bits over those fields. For a singulation command to determine the range between the reader and the tag, the command will include “version,” “domain manager” and/or “object class” when encoding the tag. The ranging encoding will further include an “FM0 preamble” for a particular modulated pattern. The modulated pattern begins with a preamble comprising eight leading “0” bits, a FM0 violation and a trailing “1” bit. For the required fixed frequency, a “Miller-modulated subcarrier” bit pattern provides a constant frequency modulation at four subcarrier cycles per bit. A portion of the tag 376 memory may be a dedicated to a bit pattern. For example, 0101 . . . may be used for simple binary encoding which will return a modulated signal for a portion of the response. In addition, extended commands, such as those used for a specific purpose may be chosen to implement a constant frequency modulation.

During a read operation in response to a trigger 319 pull, the reader 300 sends out an interrogation signal. Upon receipt of the interrogation signal an electronic tag, such as an RFID tag, may respond by sending out a modulated backscatter response containing the tag data information. The reader 300 then senses the modulated backscatter signal and processes the signal to obtain the data. Upon receipt of that response, the reader 300 interrogator transmits a modulated carrier signal to the tag 376. The tag 376 upon receipt of the modulated carrier signal sends a predicted response and on replies to subsequent commands the range of the tag is determined. The range may then be displayed on the touch screen 313. Alternately, other range feedback may be provided to the user or the range used for further processing.

Typically, a RFID read operation in a handheld device uses a trigger 319 pull and a single read command sent to the reader 300 to read all tags within the RF field 311. The reader 300 may read multiple tags within a single read operation or tag inventory operation. The tags seen in a given read operation are read sequentially according to a suitable protocol such as a query response protocol or an air interface protocol (AIP). In addition, the software and control circuit in terminal 312 may have an inventory command for a multi-protocol and/or multi-antenna reader. The inventory command may be configured to exclude certain protocols, antennas and/or a combination thereof. In addition, an inventory command may be configured to select tags with a specific fixed frequency at an extremely low duty cycle or to select a tag by hopping to a different frequency.

The electronic tags in a read volume are not always all read by the interrogator. If a particular tag of interest is not identified in a read volume, its range may not be determined during a single read operation. In a preferred embodiment, the RFID read operation is extended beyond a single read attempt by continuing multiple interrogation sequences that are undertaken until meeting terminating criteria. One method of finding the range between a RFID reader and a RFID tag includes the steps of: 1) activating a trigger 319 on the RFID reader 300 that will initiate automatic commands from the reader's control circuit to the interrogator and find a tag of interest, encoded with a fixed frequency bit pattern for responding with a predicted response that may be a backscatter response, a modulated backscatter response or a modulated backscatter response during a fixed or indefinite interval; 2) singulating by a binary search tree or other search method a population of electronic tags, such as RFID tags, using the interrogator for locating a tag of interest having a predicted response; 3) transmitting a modulated carrier signal; 4) detecting a predicted response; 5) measuring the time delay or phase shift between the modulated carrier signal and predicted response; and 6) calculating the distance between the interrogator antenna and electronic tag of interest using the time delay or the phase shift. In addition, the distance between the interrogator and the tag of interest may be displayed on a screen that may be on the terminal 312, at a remote terminal, or returning the data to an application on the portable data terminal (PDT). Furthermore, the range or distance may be input into a range location finding program.

One method of obtaining a known or predicted response period, comprises distinguishing or separating the backscattered signal of the tag of interest from all other backscattered signals in the environment. The tag of interest is distinguishable from the other tags by modulating its radar cross-section or backscatter in the manner as specified in an air interface protocol (AIP). The tag may minimize and maximize its radar cross-section by reflecting or absorbing incident radio frequency (RF) energy from the interrogator. The phase shift or time delay is not measured during the absence of a backscattered signal from the tag, which is during the backscatter minimum. The phase shift or time delay is measured during the presence of the backscattered signal, that is, the measurement is synchronous with the backscatter maximum.

For example, the tag of interest may be searched for in a warehouse. The tag in the field of the interrogator may be singulated, which is, identified so its response is known or predictable. If the tag is within the RF field of the interrogator, the tag's response may be predicted so a backscattered signal can be evaluated at the appropriate times, that is, evaluated during its signal wave periods. The phase shift or time delay is measured during the presence of the backscattered signal, that is, the measurement is synchronous with the backscatter maximum. In one embodiment, as the signal is received, the signal is digitized and stored. Once the entire signal is completed and stored the signal may be validated as the backscattered signal from the tag of interest by the microprocessor of the reader 300. Once the microprocessor validates the signal the tag range calculated.

The calculation of the range is obtained by using the following formula:
Range=Time Delay/(2×c) (1)
where c is the speed of light and time delay=ΔT. Alternately, the calculation of the distance is obtained by using the following formula:
Range=Phase shift×λ/4π (2)
where phase shift=θ and λ=the speed of light (c) divided by the frequency (f).

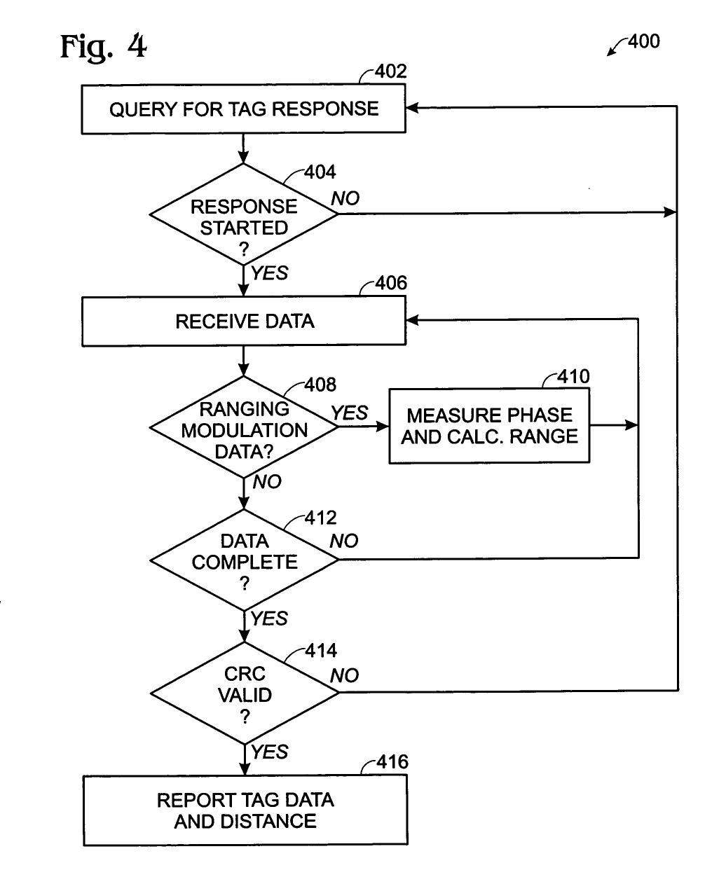

FIG. 4 illustrates a flow diagram of a preferred method 400 for singulation/ranging with an encoded ranging bit pattern in a RFID tag as described in the following steps. A user initiates the ranging by engaging a trigger pull or other means on a RFID reader to query the RFID tag to receive a modulated backscatter signal at step 402. If the tag has not responded at step 404, the RFID reader continues to query until receiving a response from the RFID tag. When the RFID reader receives a response a storage location in the reader command and control circuit receives the data at step 406 and puts it into a temporary storage. At step 408 the encoded data results in backscattering at a fixed frequency. At step 410 the range of the tag from the reader is determined by measuring the time delay or phase shift (FIG. 8) between the readers's transmitted signal and the backscatter from the tag. At step 412 if the data is not complete then the steps are repeated at step 408. When the data is complete a cyclic redundancy check algorithm (CRC) validation occurs at step 414. If the CRC is not validated then the process repeats at step 402. If the CRC is validated then at step 416 the tag data and range is reported.

If a RFID tag is configured so that a portion of its response does not vary from tag to tag, preferably at a fixed frequency, the tag may be singulated and ranged during the same command/response sequence. Any passive RFID tag may be configured in which a portion of the tag's data is fixed. In the method illustrated in FIG. 4, after the modulated signal having encoded data bits is received from the tag, ranging is initiated when the location in the bit pattern of the ranging data is reached. The ranging is completed when the data subsequent to the ranging data is obtained. The ranging is validated when the checksum or CRC (if implemented in the AIP) is received. The modulation of the interrogator signal may occur during the portion of the tag's response which is configured for ranging, which minimizes the off-peak transmitted energy spectrum. Furthermore, if a tag is configured so that all or a portion of its response to the ranging command does not vary from tag to tag, preferably at a fixed frequency or data pattern for an interval period of time, the tag may be singulated and ranged during the same command/response sequence.

Singulation and ranging may occur during the same command/response sequence using a passive RFID tag whose AIP allows it to be configured with a special command. Such a command addressed to the tag of interest may cause that tag to modulate it backscatter with a pattern which does not vary from tag to tag at a fixed frequency or data pattern and for an interval of time. A second implementation of a read command may cause the tag to respond with its identification, other data and a checksum or CRC (allowing the response to be checked for data integrity and data collisions) that is followed by a pattern which does not vary from tag to tag, at a fixed frequency or data pattern, for an interval of time. A third implementation of a read command may cause the tag to respond with a pattern which does not vary from tag to tag at a fixed frequency or data pattern, for an interval of time. The response may be either before responding or after responding to its identification or other data while the pattern detects that the carrier from the interrogator is modulated for ranging.

The range accuracy is preferably limited to a fraction of a wavelength because of signal noise and resolution. However, if the carrier frequency is modulated at a lower frequency, then the time delay or phase shift determined from a long wavelength is resolved to within one carrier wavelength. The lower frequency may be a wavelength that is an integer multiple of the inverse fraction of the wavelength. The phase shift of the carrier wavelength may then be used to resolve the distance to a greater accuracy. For example, the UHF wavelengths of the carrier frequencies used to read passive RFID tags vary between about 31 cm and 35 cm wherein the phase shift of the carrier is ambiguous at greater ranges. However, if that carrier signal is modulated at a lower frequency, or longer wavelength that is at least 3 to 4 meters, whose phase shift is resolvable to within about 30 cm, the range defined by the phase shift is accurate to within about 3 cm.

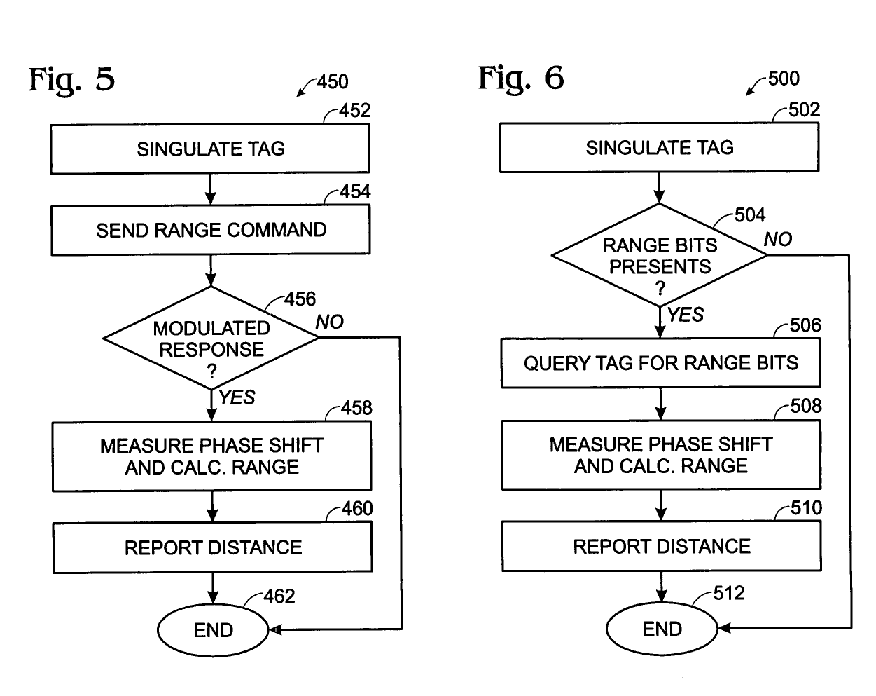

FIG. 5 illustrates a flow diagram of another method 450 for determining the range between an antenna of an interrogator and an electronic tag, such as a RFID tag including; 1) at step 452 the reader singulates the tag; 2) once the desired tag of interest is located the interrogator sends a range command at step 454; 3) the range command solicits from the tag a reflection detecting a modulated backscatter response from the RFID tag of interest at step 456, but if there is no response the reading ends at step 462; 4) if there is a response, at step 458 the distance between the antenna of the interrogator and the RFID tag may be determined by measuring the time delay or phase shift (FIG. 8) between the interrogator's transmitted modulated carrier signal and the modulated backscatter response from the tag; 5) at step 458 the distance between the antenna and the tag may be calculated using the phase shift or time delay; and 6) when step 458 is completed the distance is reported at step 460 and the reading ends at step 462. The method 450 is used if the tag responds to a command with a fixed frequency to avoid data collision. The tag is singulated so the command may be addressed to the fixed frequency. Singulation may be skipped if a specific tag is being searched for. Alternately, singulation may be accomplished using a ranging command in a search tree or other sequence that allows data collisions to be detected, for example, returning the tag identification and CRC preceding the modulated response.

FIG. 6 illustrates a flow diagram of another method 500 for determining the range between an antenna of an interrogator and an electronic tag, such as a RFID tag, including: 1) at step 502 the interrogator singulates and identifies a particular RFID tag of interest; 2) the interrogator at step 504 will identify if any range bit pattern that may be present in the RFID tag, but if there is no range bit pattern present then the reading ends at step 512; 3) if a range bit pattern is present, at step 506 the interrogator initiates a query to the RFID tag of interest calling for the bit pattern resulting in a modulated backscatter at a fixed frequency from the RFID tag; 4) at step 508 the range between the interrogator and the RFID tag may be determined by measuring a time delay or a phase shift (FIG. 8) between a transmitted modulated carrier signal from the interrogator and the modulated backscatter response from the tag; 5) at step 508 the distance between the antenna and the electronic tag may be calculated using the time delay or phase shift; and 6) when step 508 is completed the distance is reported at step 510 and the reading will end at step 512.

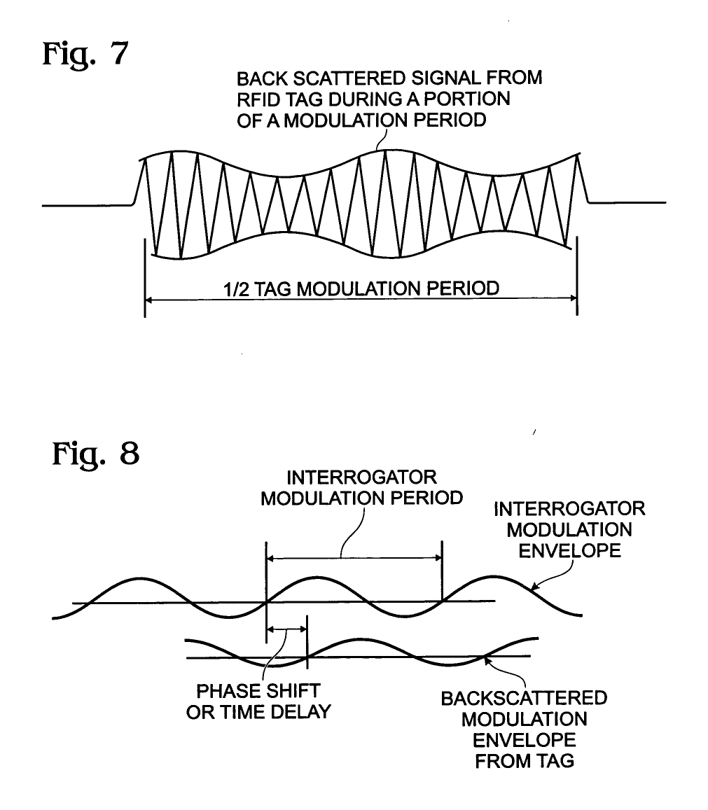

FIG. 7 illustrates a digital modulation of the backscattered signal by the RFID tag superimposed on the sinusoidal modulation from the interrogator. The digital modulation of the backscatter is from a RFID tag of interest during the portion of the modulation period configured by the encoded bit pattern in the tag. The modulation period is used in determining the time delay or phase shift between the interrogator modulation and backscattered modulation.

FIG. 8 illustrates a modulated backscattered signal with a phase shift or time delay during a portion of a read period, wherein the distance between the RFID reader and a RFID tag may be determined. First, a RFID tag is identified so that the tag's response may be known. The identification action is accomplished by activating a trigger on the RFID reader and singulating a RFID tag by the reader. After the tag is identified, a backscatter signal of the RFID tag at a fixed frequency is modulated. Next a corresponding change of a time delay or phase shift of the tag backscatter signal at the fixed frequency is measured. Once the time delay or phase frequency signal. The time delay is measured again at the higher frequency. Once the distance is verified, the read is terminated after a fixed interval and the distance between the reader and tag is displayed on a screen or processed to an application. The interval may vary to an indefinite period or as the user of the reader commands it for a specific amount of time. In addition, the screen may be that which is on the RFID reader or the distance measurement may be displayed by wireless communication to a remote terminal and screen or used as input to a position location program.

While there has been illustrated and described with reference to certain embodiments, it will be appreciated that numerous changes and modifications are likely to occur to those skilled in the art. It is intended in the appended claims to cover all those changes and modifications that fall within the spirit and scope of this disclosure and should, therefore, be determined only by the following claims and their equivalents.

What is claimed is:

1. An electronic tag comprising an encoded bit data pattern in a portion of a data field from said tag resulting in a backscatter signal from said tag when said tag responds to a read command from an interrogator.

2. The tag as claimed in claim 1, wherein said data pattern is a plurality of fixed frequencies.

3. The tag as claimed in claim 1, wherein said tag is passive.

4. An electronic tag comprising an encoded bit data pattern in a portion of a data field from said tag resulting in a modulated backscatter signal from said tag when said tag responds to a read command from an interrogator.

5. The tag as claimed in claim 4, wherein said data pattern is a plurality of fixed frequencies.

6. The tag as claimed in claim 4, wherein said tag is passive.

7. An electronic tag comprising an encoded bit data pattern in a portion of a data field from said tag resulting in a modulated backscatter signal from said tag, wherein said modulated backscatter signal is interrogated for an interval of time when said tag responds to a read command from an interrogator.

8. The tag as claimed in claim 7, where said data pattern is a plurality of fixed frequencies.

9. The tag as claimed in claim 7, where said tag is passive.

10. The tag as claimed in claim 7, where said interval of time is a plurality of intervals.

11. An electronic tag comprising:
a) an encoded bit data pattern in a portion of a data field from said tag resulting in a backscatter signal from said tag when said tag responds to a first read command from an interrogator;
b) an encoded bit data pattern in a portion of a data field from said tag resulting in a modulated backscatter signal from said tag when said tag responds to a second read command from an interrogator; and
c) an encoded bit data pattern in a portion of a data field from said tag resulting in a modulated backscatter signal from said tag, wherein said modulated backscatter signal is interrogated for an interval of time when said tag responds to a third read command from an interrogator.

12. The tag as claimed in claim 11, wherein said data pattern is a plurality of fixed frequencies.

13. The tag as claimed in claim 11, wherein said tag is passive.

14. The tag as claimed in claim 11, wherein said interval of time is a plurality of intervals.

15. A method for finding range between an antenna of an interrogator and an electronic tag comprising the steps of:
singulating a population of electronic tags using said interrogator for locating a tag of interest having a predicted response;
transmitting a modulated carrier signal;
detecting said predicted response;
measuring a time delay between said modulated carrier signal and said predicted response; and
calculating a distance between said antenna and said tag of interest using said time delay.

16. The method according to claim 15, wherein said distance is used as input to a position location program.

17. The method according to claim 15, wherein said distance is used as input to a feedback mechanism.

18. A method for finding range between an antenna of an interrogator and an electronic tag comprising the steps of:
singulating a population of electronic tags using said interrogator for locating a tag of interest having a predicted response;
transmitting a modulated carrier signal;
detecting said predicted response;
measuring a phase shift between said modulated carrier signal and said predicted response; and
calculating a distance between said antenna and said tag of interest using said phase shift.

19. The method according to claim 18, wherein said range is used as input to a position location program.

20. The method according to claim 18, wherein said range is used as input to a feedback mechanism.

21. A method for determining the range between an antenna of an interrogator and an electronic tag comprising the steps of:
singulating an electronic tag of interest;
identifying a range bit pattern in said electronic tag of interest;
initiating a query to said electronic tag of interest resulting in a modulated backscatter response;
measuring a time delay between a transmitted modulated carrier signal from said interrogator and said modulated backscatter response;
calculating a distance between said antenna and said electronic tag using said time delay; and
reporting said distance.

22. The method according to claim 21, wherein said distance is used as input to a position location program.

23. The method according to claim 21, wherein said distance is used as input to a feedback mechanism.

24. A method for determining the range between an antenna of an interrogator and an electronic tag comprising the steps of:
singulating an electronic tag of interest;
identifying a range bit pattern in said electronic tag of interest;
initiating a query to said electronic tag of interest resulting in a modulated backscatter response;
measuring a phase shift between a transmitted modulated carrier signal from said interrogator and said modulated backscatter response;
calculating a distance between said antenna and said electronic tag using said phase shift; and
reporting said distance.

25. The method according to claim 24, wherein said distance is used as input to a position location program.

26. The method according to claim 24, wherein said distance is used as input to a feedback mechanism.

27. A method for determining the range between an antenna of an interrogator and an electronic tag comprising the steps of:
singulating an electronic tag of interest;
sending a range command to said electronic tag of interest;
detecting a modulated backscatter response from said electronic tag of interest;
measuring a phase shift between a transmitted modulated carrier signal from said interrogator and said modulated backscatter response;
calculating a distance between said antenna and said electronic tag using said phase shift; and
reporting said distance.

28. The method according to claim 27, wherein said distance is used as input to a position location program.

29. The method according to claim 27, wherein said distance is used as input to a feedback mechanism.

30. A method for determining the range between an antenna of an interrogator and an electronic tag comprising the steps of:
singulating an electronic tag of interest;
sending a range command to said electronic tag of interest;
detecting a modulated backscatter response from said electronic tag of interest;
measuring a time delay between a transmitted modulated carrier signal from said interrogator and said modulated backscatter response;
calculating a distance between said antenna and said electronic tag using said time delay; and
reporting said distance.

31. The method according to claim 30, wherein said distance is used as input to a position location program.

32. The method according to claim 30, wherein said distance is used as input to a feedback mechanism.

33. A method for determining the range between an antenna of an interrogator and an electronic tag comprising the steps of:
singulating an electronic tag of interest;
sending a range command to said electronic tag of interest;
detecting a modulated backscatter response from said electronic tag of interest;
measuring a time delay between a transmitted modulated carrier signal from said interrogator and said modulated backscatter response;
calculating a distance between said antenna and said electronic tag using said time delay;
validating data integrity; and
reporting said distance.

34. The method according to claim 33, wherein said distance is used as input to a position location program.

35. The method according to claim 33, wherein said distance is used as input to a feedback mechanism.

35. A method for determining the range between an antenna of an interrogator and an electronic tag comprising the steps of:
singulating an electronic tag of interest;
sending a range command to said electronic tag of interest;
detecting a modulated backscatter response from said electronic tag of interest;
measuring a phase shift between a transmitted modulated carrier signal from said interrogator and said modulated backscatter response;
calculating a distance between said antenna and said electronic tag using said phase shift;
validating data integrity; and
reporting said distance.

36. The method according to claim 35, wherein said distance is used as input to a position location program.

37. The method according to claim 35, wherein said distance is used as input to a feedback mechanism.
